(19) United States
(12) Patent Application Publication
(10) Pub. No.: US 2011/0128214 A1
(43) Pub. Date: Jun. 2, 2011

(54) DISPLAY PANEL

(75) Inventors: Chou-Chin Wu, Taipei County (TW); I-Chun Chen, Taoyuan County (TW); Ming-Hung Shih, Pingtung County (TW); Chu-Yu Liu, Hsinchu County (TW)

(73) Assignee: AU OPTRONICS CORPORATION, Hsinchu (TW)

(21) Appl. No.: 12/720,675

(22) Filed: Mar. 10, 2010

(30) Foreign Application Priority Data
Nov. 27, 2009 (TW) 98140666

(51) Int. Cl. G09G 3/36

(52) U.S. Cl. 345/98

(57) ABSTRACT

A display panel includes an array substrate, an opposite substrate and a display medium layer. A plurality of ring-like common lines of the array substrate are respectively located between two adjacent scan lines, and a plurality of date lines intersect with the scan lines and the ring-like common lines. Each pixel unit of the array substrate includes an active device, a pixel electrode and a connecting line. Each of the connecting line intersects with one of the scan lines and is electrically connected to the two adjacent ring-like common lines so as to connect the ring-like common lines to form a meshed common line. A transparent region is defined by a black matrix layer of the opposite substrate and the ring-like common lines. The black matrix layer does not cover the ring-like common lines at the corner of the transparent region near the connecting lines.

### CROSS-REFERENCE TO RELATED APPLICATION

This application claims the priority benefit of Taiwan application serial no. 98140666, filed on Nov. 27, 2009. The entirety of the above-mentioned patent application is hereby incorporated by reference herein and made a part of specification.

### BACKGROUND OF THE INVENTION

1. Field of the Invention

The invention generally relates to a display panel, and more particularly to a display panel having a high aperture ratio (AR).

2. Description of Related Art

By virtue of increasing demands for displays and a rising awareness of environmental protection, a liquid crystal display (LCD) featuring superior properties including high definition, optimal space utilization, low power consumption, and no radiation has gradually become the mainstream product in the market of the displays. Generally speaking, the LCD mainly includes two substrates and a liquid crystal layer disposed therebetween. A plurality of pixel units are disposed on one of the substrates to control an orientation of liquid crystal molecules for frame display.

In order to overcome an issue of light leakage between two adjacent pixel electrodes as well as manufacturing limitations, typically a black matrix layer for light shielding is produced on another substrate. However, when two substrates are assembled, an alignment error is unavoidable. Therefore, to ensure a preferable light shielding effect for the black matrix layer, typically during manufacture of the black matrix layer, a transparent region of the black matrix layer is configured to be smaller than the pixel electrode region. By encompassing a larger area, the black matrix layer may avoid an issue of ineffective light shielding due to insufficient alignment accuracy. However, the transparent region of the black matrix layer consequently determines a display aperture area. That is to say, the black matrix layer encompassing a large area affects an aperture ratio of the display panel, and thereby causes an issue of a reduction in the aperture ratio of the display panel.

### SUMMARY OF THE INVENTION

An aspect of the invention provides a display panel having a high aperture ratio.

An aspect of the invention provides a display panel including an array substrate, an opposite substrate, and a display medium layer. The array substrate includes a plurality of scan lines, a plurality of data lines, a plurality of pixel units connected to the scan lines and the data lines, and a plurality of ring-like common lines. Each of the ring-like common lines is respectively disposed between the two adjacent scan lines, and the data lines intersect with the scan lines and the ring-like common lines. Each of the pixel units includes an active device, a pixel electrode, and a connecting line. The pixel electrode is electrically connected to the active device, and the pixel electrode overlaps one of the ring-like common lines. The connecting line intersects with one of the scan lines and is electrically connected to two adjacent ring-like common lines, so as to connect the ring-like common lines to form a meshed common line. The opposite substrate is disposed above the array substrate, and the opposite substrate has a black matrix layer. The black matrix layer and the ring-like common lines define a transparent region. In addition, the black matrix layer does not cover at least one of the ring-like common lines at a corner of the transparent region near each of the connecting lines. Alternatively, the black matrix layer and the ring-like common lines are substantially aligned at the corner. The display medium layer is disposed between the array substrate and the opposite substrate.

In one embodiment of the invention, the above-described active device includes a thin film transistor (TFT), and the pixel electrodes include transparent pixel electrodes.

In one embodiment of the invention, a material of the above-described pixel electrodes and a material of the connecting lines are substantially the same.

In one embodiment of the invention, the aforementioned array substrate further includes a dielectric layer covering the ring-like common lines, and the dielectric layer has a plurality of contact holes for exposing a portion of the ring-like common lines. Moreover, the connecting lines are electrically connected to the ring-like common lines through the contact holes.

In one embodiment of the invention, the black matrix layer covers an outer edge of each of the above-described pixel electrodes.

In one embodiment of the invention, the above-described black matrix layer has a plurality of openings, and each of the openings exposes a portion of one of the pixel electrodes and a portion of one of the ring-like common lines.

In one embodiment of the invention, at the above-described corner of the transparent region near each of the connecting lines, the pixel electrodes are covered by the ring-like common lines.

In summary, an embodiment of the invention uses the ring-like common lines of the array substrate and the black matrix layer of the opposite substrate to define a boundary of the transparent region, which is also the display region of the display panel. Moreover, at the corner of the transparent region near each of the connecting lines, the black matrix layer does not cover the ring-like common line, or the black matrix layer and the ring-like common lines are substantially aligned at the corner. Therefore, compared to conventional techniques, the invention as embodied and broadly described herein may effectively increase the aperture ratio of the display panel, particularly at the corner of the transparent region near each of the connecting lines. In other words, by using a complementary design of the ring-like common lines and the black matrix layer according to the invention as embodied herein, the aperture ratio of the display panel can be increased, and the display quality of the display panel can be enhanced.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic top view of a display panel in accordance with an embodiment of the invention.

FIGS. 1B-1E are partial schematic top views of the display panel depicted in FIG. 1A.

FIG. 1F is a schematic cross-sectional view taken along a line I-I′ depicted in FIG. 1A.

### DESCRIPTION OF EMBODIMENTS

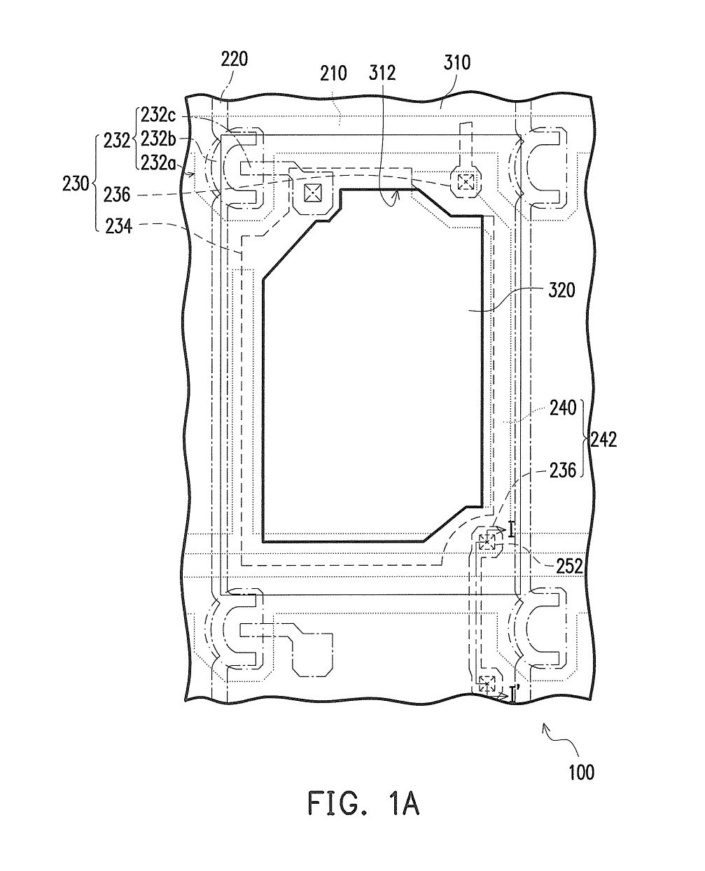

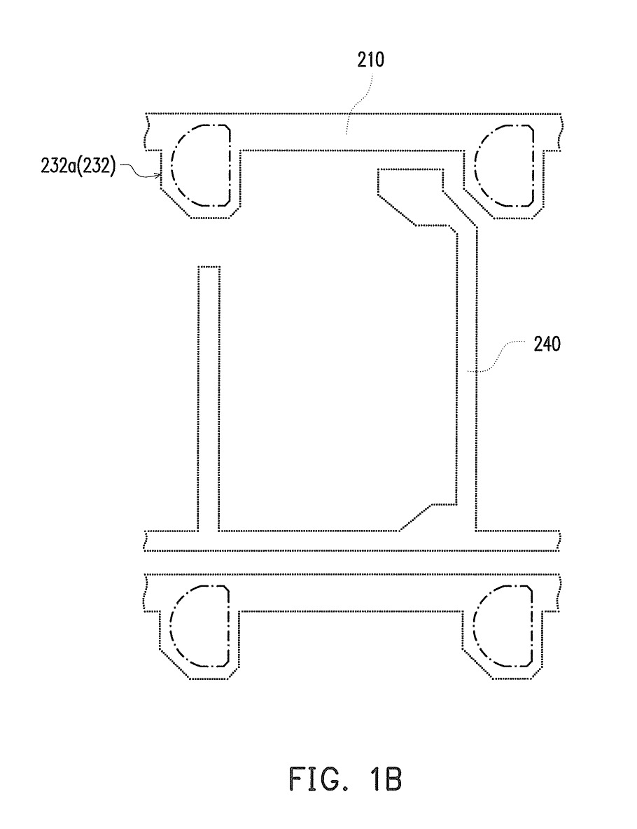

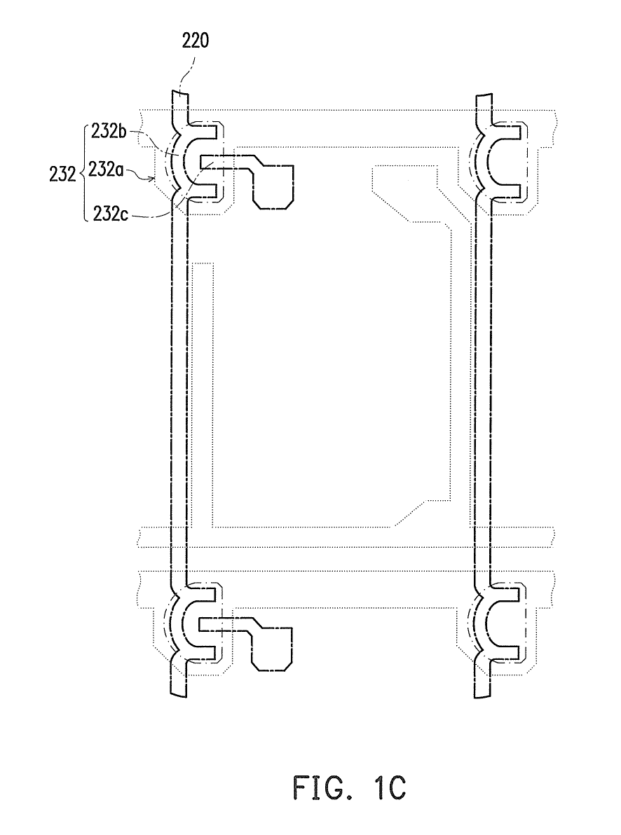

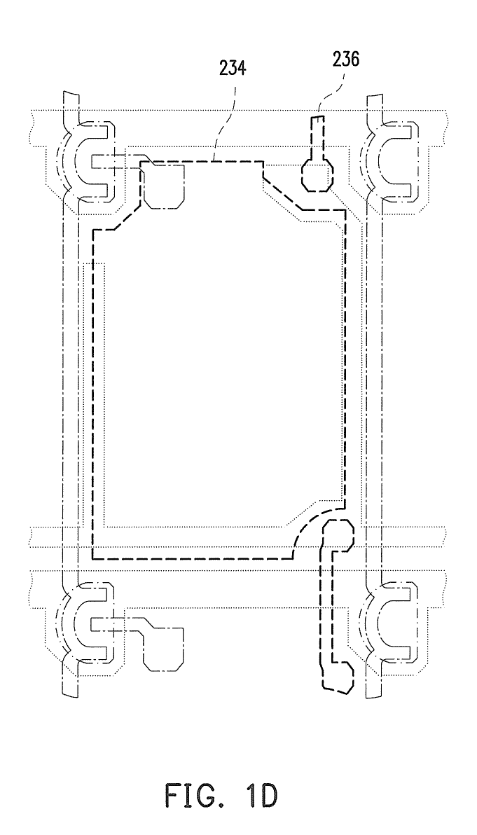

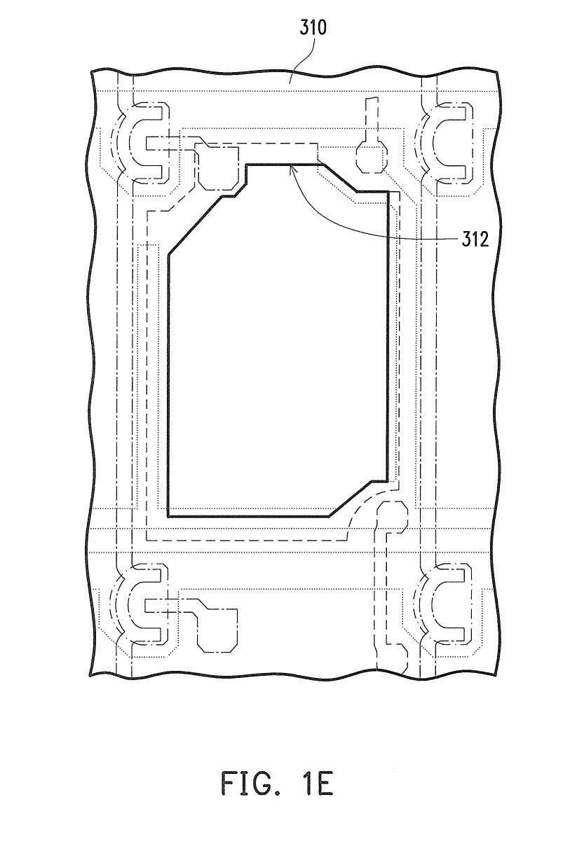

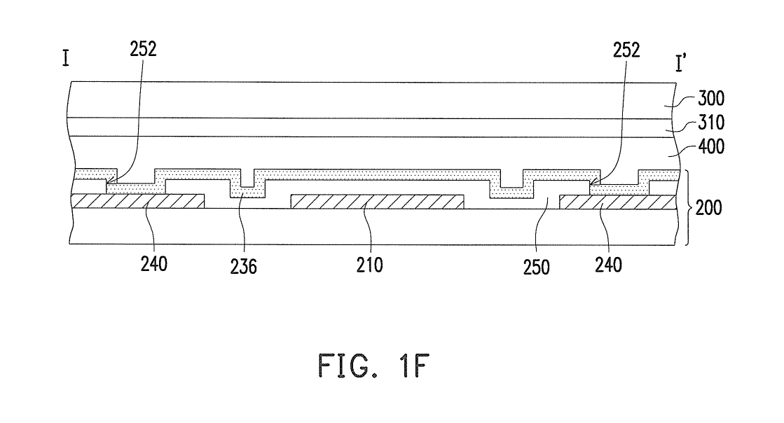

FIG. 1A is a schematic top view of a display panel in accordance with an embodiment of the invention. FIGS. 1B-1E are partial schematic top views of the display panel depicted in FIG. 1A. FIG. 1F is a schematic cross-sectional view taken along a line I-I′ depicted in FIG. 1A. Referring to FIGS. 1A and 1F, in the present embodiment of the invention, a display panel 100 includes an array substrate 200, an opposite substrate 300, and a display medium layer 400. The opposite substrate is disposed above the array substrate 200, and the display medium layer 400 is disposed between the array substrate 200 and the opposite substrate 300. The aforementioned display medium layer 400 is a liquid crystal layer, for example.

Specifically, referring to FIGS. 1A-1C, the array substrate 200 has a plurality of scan lines 210, a plurality of data lines 220, a plurality of pixel units 230 connected to the scan lines 210 and the data lines 220, a plurality of ring-like common lines 240, and a dielectric layer 250 (please also see FIG. 1F). Herein, each of the ring-like common lines 240 is respectively disposed between the two adjacent scan lines 210, and the data lines intersect with the scan lines 210 and the ring-like common lines 240. Each of the pixel units 230 includes an active device 232, a pixel electrode 234, and a connecting line 236. The pixel electrode 234 is electrically connected to the active device 232, and the pixel electrode 234 overlaps the ring-like common lines 240. Each of the connecting lines 236 intersects with one of the scan lines 210 and is electrically connected to the two adjacent ring-like common lines 240, so as to connect the ring-like common lines 240 to form a meshed common line 242. Moreover, referring to FIG. 1F, the dielectric layer 250 covers the ring-like common lines 240, and the dielectric layer 250 has a plurality of contact holes 252 for exposing a portion of the ring-like common lines 240. Herein, the connecting line 236 can be electrically connected to the ring-like common lines 240 through the contact holes 252.

In the present embodiment of the invention, the active device 232 is, for example, a thin film transistor (TFT) formed by a gate 232a, a source 232b, and a drain 232c. Moreover, the pixel electrode 234 is a transparent pixel electrode, for example, and a material of pixel electrode 234 includes, for instance, Indium Tin Oxide (ITO) or Indium Zinc Oxide (IZO). Particularly, the material of the pixel electrode 234 in the present embodiment is substantially the same as a material of the connecting line 236. In other words, the material of the connecting line 236 can include ITO or IZO.

Referring to FIGS. 1A, 1D, and 1E, the opposite substrate 300 has a black matrix layer 310, and an outer boundary of each pixel electrode 234 is covered by the black matrix layer 310. More specifically, in the present embodiment of the invention, the black matrix layer 310 and the ring-like common lines 240 define a transparent region 320 that is the display region of the display panel 100. At a corner of the transparent region near each of the connecting lines 236 (e.g., a bottom right corner and a top right corner of FIG. 1A), the black matrix layer 310 does not cover the ring-like common lines 240 (e.g., at the top right corner of FIG. 1A). For example, at the top right corner of FIG. 1A, the black matrix layer 310 is disposed at an outer side of the ring-like common lines 240. Alternatively, the black matrix layer 310 and the ring-like common line may be substantially aligned at the corner (e.g., the bottom right corner of FIG. 1A). Moreover, the black matrix layer 310 has a plurality of openings 312, and each of the openings 312 expose a portion of one of the pixel electrodes 234 and a portion of one of the ring-like common lines 240.

In the present embodiment of the invention, the pixel electrodes 234 and the ring-like common lines 240 overlap each other. Particularly, at the corner of the transparent region near each of the connecting lines 236 (e.g., the bottom right corner and the top right corner of FIG. 1A), the pixel electrodes 234 are covered by the ring-like common lines 240. Therefore, when the array substrate 200 and the opposite substrate 300 are being assembled, by defining the display region of the display panel 100 with the black matrix layer 310 on the opposite substrate 300 and the ring-like common lines on the array substrate 200, an aperture ratio of the display panel 100 is not affected by an alignment accuracy as significantly. Accordingly, the aperture ratio of the display panel 100 may be increased. In other words, the display panel 100 according to the present embodiment has an enhanced display quality.

Moreover, at the corner of the transparent region 320 near each of the connecting lines 236, the black matrix layer 310 does not cover the ring-like common lines 240, or the black matrix layer 310 and the ring-like common lines 240 are substantially aligned at the corner. Therefore, compared to a conventional display panel, the display panel 100 of the present embodiment has an increased aperture ratio.

In light of the foregoing, an embodiment of the invention uses the ring-like common lines of the array substrate and the black matrix layer of the opposite substrate to define a boundary of the transparent region, which is also the display region of the display panel. At the same time, at the corner of the transparent region near each of the connecting lines, the black matrix layer does not cover the ring-like common lines, or the black matrix layer and the ring-like common lines are substantially aligned at the corner. Therefore, compared to conventional techniques, the invention as embodied and broadly described herein may effectively increase the aperture ratio of the display panel, particularly at the corner of the transparent region near the connecting lines. In other words, by using a complementary design of the ring-like common lines and the black matrix layer according to the invention as embodied herein, the aperture ratio of the display panel may be increased, and the display quality of the display panel may be enhanced.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A display panel, comprising:
an array substrate comprising a plurality of scan lines, a plurality of data lines, a plurality of pixel units connected to the scan lines and the data lines, and a plurality of ring-like common lines, wherein each of the ring-like common lines is respectively disposed between the two adjacent scan lines, the data lines intersecting with the scan lines and the ring-like common lines, and each of the pixel units comprises:
an active device;
a pixel electrode electrically connected to the active device, wherein the pixel electrode overlaps one of the ring-like common lines;
a connecting line intersected with one of the scan lines and electrically connected to the two adjacent ring-like common lines, so as to connect the ring-like common lines to form a meshed common line;
an opposite substrate disposed above the array substrate, wherein the opposite substrate has a black matrix layer, the black matrix layer and the ring-like common lines define a transparent region, and the black matrix layer does not cover at least one of the ring-like common lines at a corner of the transparent region near each of the connecting lines, or the black matrix layer and at least one of the ring-like common lines are substantially aligned at the corner; and
a display medium layer disposed between the array substrate and the opposite substrate.

2. The display panel as claimed in claim 1, wherein the active devices are thin film transistors, and the pixel electrodes are transparent pixel electrodes.

3. The display panel as claimed in claim 1, wherein a material of the pixel electrodes and a material of the connecting lines are substantially the same.

4. The display panel as claimed in claim 1, wherein the array substrate further comprises a dielectric layer covering the ring-like common lines and having a plurality of contact holes for exposing a portion of the ring-like common lines, and the connecting lines are electrically connected to the ring-like common lines through the contact holes.

5. The display panel as claimed in claim 1, wherein an outer edge of each of the pixel electrodes is covered by the black matrix layer.

6. The display panel as claimed in claim 1, wherein the black matrix layer has a plurality of openings, and each of the openings exposes a portion of one of the pixel electrodes and a portion of one of the ring-like common lines.

7. The display panel as claimed in claim 1, wherein at the corner of the transparent region near each of the connecting lines, the pixel electrodes are covered by the ring-like common lines.
